(19) United States
(12) Patent Application Publication
(10) Pub. No.: US 2014/0304713 A1
(43) Pub. Date: Oct. 9, 2014

(54) METHOD AND APPARATUS FOR DISTRIBUTED PROCESSING TASKS

(71) Applicants: Hjalmar Olsson, Bromma (SE); Simon Moritz, Stockholm (SE)

(72) Inventors: Hjalmar Olsson, Bromma (SE); Simon Moritz, Stockholm (SE)

(73) Assignee: Telefonaktiebolaget L M Ericsson (pulb), Stockholm (SE)

(21) Appl. No.: 14/359,729

(22) PCT Filed: Nov. 23, 2011
(86) PCT No.: PCT/SE2011/051409

§ 371 Date: May 21, 2014

(51) Int. Cl. G06F 9/48

(52) U.S. Cl. CPC G06F 9/4881
USPC 718/106

(57) ABSTRACT

Methods and apparatuses for realizing and enabling a requested computational main task by operation of a task manager and a service node. The task manager defines a set of sub-tasks that accomplish the main task, and sends a source code to the service node including a device instruction for a device connected to the service node, to fetch and execute a sub-task from the task manager. The service node then sends the source code to the device which accordingly fetches and executes the sub-task according to the instruction. When the task manager has received enough sub-task results such that the main task has been completed, it returns an aggregated total result of the main task in response to the main task request.

### TECHNICAL FIELD

The present disclosure relates generally to methods and apparatuses for enabling distributed processing of computer executed tasks.

### BACKGROUND

The concept of “cloud computing” has been established in recent years as a technology for delivering services to clients in need of computational functionality, e.g. involving various operations for processing and storing data. This development is driven by the need of various clients for processing and storing capacity without the clients themselves having to invest in such capacity. It can thus provide for a temporary increase of capacity as to meet the clients' needs without them buying new hardware equipment.

The clients in this context may be associated with any enterprises, companies, organizations, private persons, etc. Cloud computing means that the client does not have to invest in expensive hardware equipment, operative systems and software functionality, as well as maintenance and administration, to provide for the needs in terms of computational capacity. Instead, resources such as hardware infrastructure and platforms can be hired from a provider of cloud computing services, which may be referred to as a “cloud computing provider” for short, hosting clusters of computers and other resources that can be allocated to hiring clients.

Typically, cloud computing services can be consumed and utilized for a preset time period, and the hiring client can basically rely on any amount of resources at any time during the period of hiring as required, while the cloud computing service is fully managed by the cloud computing provider. Significant developments in virtualization and distributed computing, as well as improved access to high-speed Internet and generally greater cost-awareness, have enabled and increased the interest for cloud computing.

FIG. 1 is a simplified and schematic illustration of how cloud computing services may be utilized by a client 100. A cloud computing provider 102 has control of a set of computational resources in a cloud 104, which is basically a computer network that may include hardware equipment, basic software with capabilities for processing and storing tasks, and software functionality, e.g. processors, computers, servers, memories, data storages, operative systems, software products, etc. These resources can be configured to perform various cloud computing services for a great number of clients, and it is typically assumed that the capacity of the cloud or computer network is more or less unlimited, at least from the individual clients' viewpoint. In this description, the term “resource” is used to generally represent any hardware equipment and software which can be used for enabling the cloud computing services and IT services.

In an action 1:1, the client 100 makes a request to the cloud computing provider 102 for a specific cloud computing service which may have been selected from a set of predefined cloud computing services offered by the provider 102. The cloud computing provider 102 then allocates, i.e. reserves, and configures resources in the cloud 104 needed to realize the requested cloud computing service, in an action 1:2. The resource allocation in the cloud 104 is typically time-limited such that the cloud computing service and reserved resources can be utilized by the client 100, but not by others, for a prescribed period of time, after which the resources are released and become available for other cloud computing services and clients. Other limitations may also be imposed for the cloud computing service, e.g. in terms of bandwidth, capacity and data amounts.

Once the proper resources have been allocated in the cloud 104, the requested service is executed by the allocated resources, in an action 1:3, and the results are then finally delivered to the client 100 in an action 1:4. As said above, FIG. 1 is greatly simplified and the shown cloud computing provider node 102 may comprise various functions and entities for managing cloud computing services, client requests and resources, such as: a user interface, an entity for maintenance of a cloud computing service catalogue or the like, an entity for management of available resources in the cloud 104, an entity for resource allocation and configuration, an entity for monitoring and metering resource usage, and so forth.

Even though the above scenario can provide substantial computational power temporarily to clients, which thereby do not need to invest in expensive resources themselves, the cloud computing provider 102 must nevertheless own and control a huge amount of resources in order to meet the demands for cloud computing services from various clients. It is predicted that the need for computational power will increase rapidly in the near future, e.g. in the fields of technology, economy and entertainment. In particular, a great variety of algorithms are now available for processing massive amounts of data, e.g. in contexts such as Machine Learning, Data Mining, Recommender Systems, User Personalization, Data Modeling, weather forecasts, various scientific simulation trials such as computational fluid dynamics and combustion simulations, to mention a few examples. These algorithms typically require substantial amounts of resources to operate in parallel computations, e.g. in iterative calculation processes, and have therefore been adapted and optimized for such parallelization. As a result, the huge capacity needed in the cloud systems of today is associated with great complexity and high costs, and may still be insufficient for future demands.

Another problem with using the above-described solution with a centralized cloud of resources is that the utilization of resources can be rather inefficient since resources being reserved to a hiring client are not available for other clients, even though the allocated resources may be left unused for extensive lengths of time during the hiring period. Therefore, the cloud computing provider must host a much greater amount of resources than actually being required for active use at the same time. Unreasonable over-capacity would consequently be required in the cloud of resources to provide temporarily dedicated resources for a large number of clients with great computational demands at the same time, since all these reserved resources will not actually be needed and used simultaneously in practice.

### SUMMARY

It is an object of the invention to address at least some of the problems and issues outlined above. It is possible to achieve these objects and others by using methods and apparatuses as defined in the attached independent claims.

According to one aspect, a method is provided in a task manager for realizing a requested computational main task. In this method, a set of sub-tasks are defined that accomplish the main task. Further, the task manager sends a source code to a service node, which source code comprises a device instruction, for a device connected to the service node, to fetch and execute at least one of the sub-tasks from the task manager.

The task manager then sends the at least one sub-task to the device in response to a sub-task fetch request sent from the device according to the device instruction in the source code. At some point later, a result of executed sub-task(s) is received, either from the device or from the service node if the device delivers the result to the service node. When the main task has been completed, e.g. after receiving results of executed sub-tasks from further devices, the task manager can finally return an aggregated result of the requested main task from received results of the defined sub-tasks, in response to the main task request.

According to another aspect, a task manager is provided which is configured to realize a requested computational main task. The task manager comprises a logic unit adapted to define a set of sub-tasks that accomplish the main task, and a first communication unit adapted to send a source code to a service node. In practice, the source code may be sent to any number of service nodes and the solution is not limited in this respect. The sent source code comprises a device instruction, for a device connected to the service node, to fetch and execute at least one of the sub-tasks from the task manager.

The task manager also comprises a second communication unit adapted to send the at least one sub-task to the device in response to a sub-task fetch request sent from the device according to the device instruction in the source code, and to receive a result of executed sub-task(s) from the device, or from the service node if the device delivers the result to the service node. The task manager also comprises a third communication unit adapted to return an aggregated result of the requested main task from received results of the defined sub-tasks, in response to the main task request, once the main task has been completed.

The above task manager method and task manager may be configured and implemented according to different optional embodiments. In one possible embodiment, the set of sub-tasks involve operations for processing data that resides in the device or in a data storage that can be accessed by the device. Further, the sub-task fetch request from the device may comprise capabilities of the device, and the at least one sub-task may be selected for the device based on those capabilities which may, without limitation, refer to any of: computing resources, graphical resources, storing capacity, communication bandwidth, device availability, and power consumption.

According to another aspect, a computer program comprises computer readable code means, which when run in the above task manager causes the task manager to perform the above corresponding task manager method. According to another aspect, a computer program product comprises a computer readable medium and the above computer program for the task manager, wherein the computer program is stored on the computer readable medium.

According to another aspect, a method is provided in a service node for enabling a requested computational main task. In this method, the service node receives a source code from a task manager, the source code comprising a device instruction to fetch at least one sub-task from the task manager selected from a set of defined sub-tasks that accomplish the main task. The service node then sends the source code to a device that is connected to the service node, to entail the device to fetch and execute the at least one sub-task according to the instruction in the source code.

According to another aspect, a service node is provided which is configured to enable a requested computational main task. The service node comprises a first communication unit adapted to receive a source code from a task manager, where the source code comprises a device instruction to fetch at least one sub-task from the task manager selected from a set of defined sub-tasks that accomplish the main task. The service node also comprises a second communication unit adapted to send the source code to a device that is connected to the service node, to entail the device to fetch and execute the at least one sub-task according to the instruction in the source code.

The above service node method and service node may be configured and implemented according to different optional embodiments. In one possible embodiment, the source code may be sent to the device upon receiving a service request. The service node may for example be a web server and the source code may in that case instruct the device to execute the at least one sub-task during a browsing session with the web server.

According to another aspect, a computer program comprises computer readable code means, which when run in the above service node causes the service node to perform the above corresponding service node method. According to another aspect, a computer program product comprises a computer readable medium and the above computer program for the service node, wherein the computer program is stored on the computer readable medium.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 is a communication scenario illustrating a cloud computing solution, according to the prior art.

FIG. 2 is a communication scenario illustrating how a computational task can be realized in this solution, according to some possible embodiments.

FIG. 3 is a flow chart illustrating a procedure in a task manager, according to further possible embodiments.

FIG. 4 is a flow chart illustrating a procedure in a service node, according to further possible embodiments.

FIG. 5 is a signalling diagram illustrating a more detailed example when the solution is used in practice involving a task manager and a web server acting as service node, according to further possible embodiments.

FIG. 6 is a block diagram illustrating a task manager and a service node in more detail, according to further possible embodiments.

### DETAILED DESCRIPTION

Briefly described, a solution is provided to achieve distributed processing of computer executed tasks by utilizing resources and computational power residing in various devices owned and controlled by individual users. The amount of such available resource capacity is virtually unlimited and undoubtedly much greater than what can be achieved by the conventional cloud computing technique described above. This distributed resource capacity is mostly unused for considerable periods of time and can instead be used for this solution during such periods without disturbing the device users or regular functions in the devices. Further, the solution does not exclude that such capacity in one or more devices could be utilized in combination with capacity in a conventional dedicated cloud or computer network, such as the cloud/computer network 104 described for FIG. 1. For example, a cloud computing provider may have a limited amount of dedicated resources in its computer network and can, if needed, employ device resources according to this solution, e.g. when the currently available resources in the computer network are insufficient to execute a particular task.

In the following, the term “device” is used to represent any user-controlled communication entity capable of performing computational tasks and delivering the results to a task manager or the like or to a service node which then can forward the results to the task manager, depending on the implementation. Some non-limiting examples of such devices include personal computers, laptops, mobile phones, game consoles, web browsers, and so forth. The task manager is a functional entity that may be implemented in any suitable new or existing network node or server, or in plural servers in a distributed manner. Further, the term “client” is used for any party that wants to have a computational task executed.

In this solution, when a request for a resource-demanding computational main task is received from a client, the task manager registers one or more service nodes that have customers using their services by means of devices having resources that can be utilized for accomplishing the requested main task. The service nodes in this context may be owned and controlled by any providers of communication-based services, such as suppliers of media content or web pages which is used in an example to be described below, although the solution is not limited to any particular types of service nodes.

The requested main task is divided into multiple sub-tasks, suitable for execution in one or more devices, and when a device communicates with a registered service node for consuming a service therefrom, the service node sends a source code to the device with an instruction to fetch a sub-task from the task manager. The device then automatically performs the fetched sub-task “in the background”, i.e. when not occupied by user activities or other operations, and delivers the result to the task manager, e.g. as a compensation or the like for using the service in the service node. The sub-task can be done during, before or after the service is consumed and the solution is not limited in this respect. As indicated above, some sub-tasks may be executed by resources in a dedicated cloud as well. When one or more devices execute such sub-tasks and deliver the results, the task manager can aggregate the received sub-task results into a total result of the main task which is finally returned to the requesting client.

Effectively, this solution enables the device owner to lend its resources to the task manager e.g. in compensation for using the service supplied by the service node. This mechanism may thus be used as an alternative or complement to paying for the service with money, or instead of enduring commercials and advertisements during the service usage which is otherwise a common way of “paying” for the service. For example, web pages are often financed by extensive advertising which can be perceived as disturbing to persons downloading the pages, which can be avoided when utilizing the present solution.

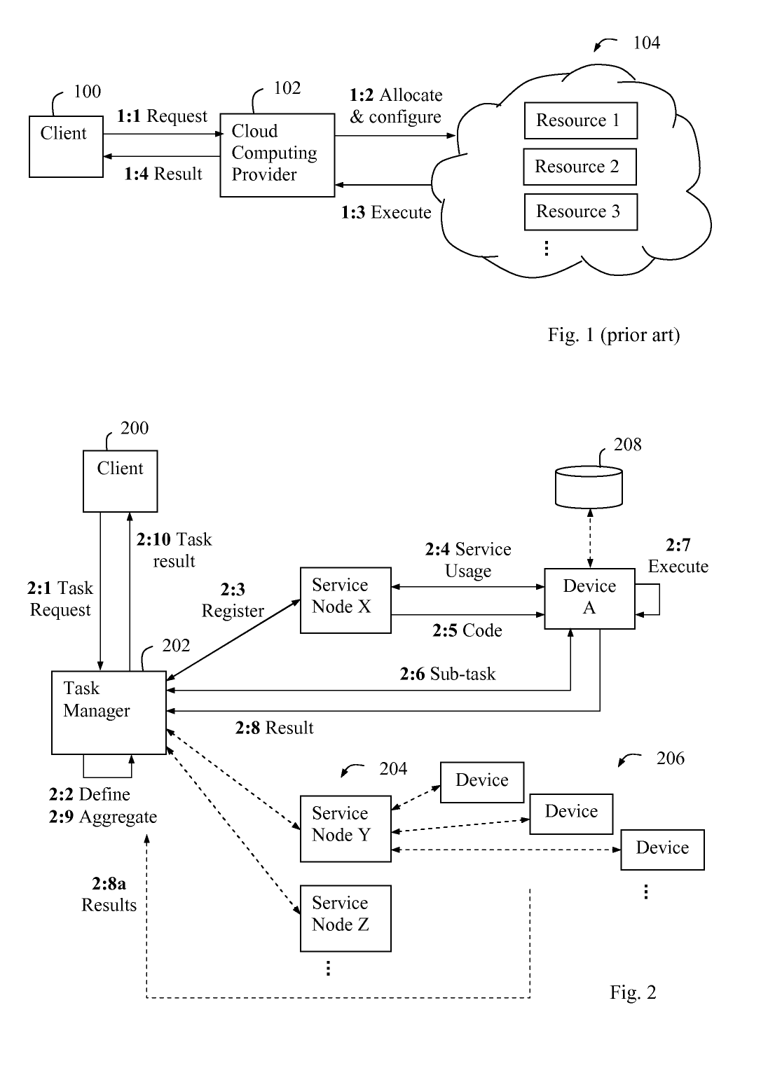

The solution will now be explained in more detail with reference to some examples illustrated in FIGS. 2-6. It should be noted that although some of these examples are described to involve just one device, the solution can be employed for any number of devices, depending on the implementation and need for resources.

Firstly, FIG. 2 illustrates an exemplifying communication scenario where a client 200 contacts a task manager 202 for accomplishing a particular computational task, which will herein be called a “main task” for short. A first action 2:1 thus illustrates that the client 200 sends a task request to the task manager 202, e.g. in order to get the computational task executed without having to use its own computational resources, if any exist.

In a further action 2:2, the task manager 202 defines a set of sub-tasks that basically accomplish the requested main task. In other words, the main task is effectively divided into a plurality of sub-tasks which together make up the main task. The set of sub-tasks may involve operations for processing data, which data may reside in the device itself or in a data storage 208 that can be accessed by the device if needed according to the sub-task to be done. If the device processes data locally stored in the device, privacy and integrity can be preserved by not communicating that data outside the device, which could be a beneficial option in this solution. Still, it is possible to use that data, and locally stored data in other devices as well, to achieve the main task. For example, sensitive personal data may be needed in a main task of computing consumer statistics, analyzing user behaviour, and so forth.

In the above action, the sub-tasks are preferably defined to be executable by ordinary devices and may be differentiated to suit different types of devices in different circumstances. For example, one sub-task may require substantial computing capacity while another sub-task may require a large memory and/or communication of large amounts of data, and so forth. In this way, specific sub-tasks can be selected for specific devices depending on the capabilities of the devices, to be described in more detail below.

Another action 2:3 illustrates that the task manager 202 registers a service node “X” effectively as a means for enabling that one or more sub-tasks are distributed to one or more devices to jointly execute the main task, as follows. Possibly, the service node X may have been registered in beforehand to act as such a “task distribution enabler” for any computational tasks requested from any clients. In addition, any number of further service nodes “Y”, “Z”, . . . may be registered in this way, e.g. in advance or triggered by the task request 2:1, to act as task distributors in a corresponding manner.

In this solution, it is thus possible for any number of service nodes X, Y, Z, . . . to be enrolled to serve the task manager 202 in the manner described herein, either triggered by specific task requests as in the example of FIG. 2 or in advance, that is in a preparation procedure where the service node owners somehow agrees with the task manager owner to register and enroll their service nodes to act as described below, whenever needed. In the latter case, the initiative may be taken by either part, e.g. the task manager owner may invite the service nodes to participate, or the service node owners may offer to participate.

During the registration procedure of action 2:3 in this example, the task manager 202 sends a source code to service node X, and possibly also to the other service nodes Y, Z, . . . , the source code comprising a device instruction to fetch and execute at least one of the above-defined sub-tasks from the task manager, for a device connected to the service node. In a next action 2:4, a device “A” connects to the service node X, e.g. in order to consume a service from node X which could be any type of service without limitation to this solution. For example, the service node X may be a web server providing web pages to devices in a browsing session or the like. In another example, the service node X may be a provider of media content and consuming a service may involve streaming of data or a file download. As mentioned above, this solution is not limited to any particular types of service node or services. The service usage of action 2:4 may continue more or less at the same time as the following actions involving the device A.

While the device A is connected to the service node X, the latter sends the above-mentioned source code to device A, in a further action 2:5, effectively to entail the device to fetch and execute the at least one sub-task according to said instruction in the source code, which is further illustrated by another action 2:6. In this action, device A sends a sub-task fetch request to the task manager 202 and receives one or more selected sub-tasks in return, which may be in java script format or any other suitable format that can be executed by the device. During this procedure, the device user may be prompted to accept the usage of resources or not, before the sub-task is fetched and executed.

The sub-task fetch request may also comprise capabilities of the device A, wherein the at least one sub-task can be selected based on said capabilities such that device A is capable of executing the selected sub-task(s). Another useful option could be that the task manager retrieves the capabilities of the device from a database in the serving communication network, e.g. a Home Location Register (HLR) or Home Subscriber Server (HSS) which normally hold capability related information on their subscribers' devices. Yet another possible option is that the task manager obtains the capabilities of the device in a dialogue with the device where such information is requested from the device. In such a dialogue, information on capabilities may be sent from the device to the task manager by means of REST calls.

For example, the capabilities included in the sub-task fetch request or otherwise obtained by the task manager may refer to any of: computing resources, graphical resources, storing capacity, communication bandwidth such as protocols and standards used by the device for radio communication, device availability e.g. the type of connection or network currently used by the device, and power consumption. The capabilities of communication bandwidth and availability imply that the device may be required to communicate data when executing a sub-task or to fetch further sub-tasks. Further, the device's availability can also be deduced from information on how frequent the device has been used in the past, which time zone it is currently located, etc., which information may be obtained from an HLR or HSS or from the device. Power consumption refers to how the device is powered, e.g. by battery, sun cells, wind, oil or water.

Just as an example, the capabilities and possible bandwidth (e.g. downlink and uplink) of a device compliant with the requirements of the 3rd Generation Partnership Project Evolved Packet Core (3GPP EPC) may be retrieved with the help of a User Equipment (UE) category defined in 3GPP TS 36.306 V. 8.8.0 and conveyed in a Radio Resource Control (RRC) message according to 3GPP TS 36.331 8.15.0. However, such information may also be carried by higher layer messages.

In practice, the main task may be divided into a range of different sub-tasks which are distributed to various devices 206 when fetched according to the source code sent to the devices from one or more service nodes X, Y, Z, . . . and depending on capabilities of the devices. Thus, when the task manager receives the sub-task fetch request indicating any of the above capabilities of the device, the task manager selects at least one sub-task for the device based on said capabilities in the sub-task fetch request. In this solution, it is thus possible to select sub-tasks for suitable devices to let the devices execute those sub-tasks they are specifically fit for.

To mention a few examples, a sub-task requiring advanced computations may be selected for a device with a powerful processor. Another sub-task requiring retrieval of much data from storage 208, or requiring frequent reporting of results during the execution, may be selected for a device with a broadband connection, and so forth. Further, a sub-task may also be selected according to availability and ability of the device based on track records of previously executed sub-tasks, e.g. a device that has not been able to deliver acceptable results in the past should not be given such sub-tasks in the future. Different sub-tasks may also have different response needs and priorities, and this can be taken into account as well when selecting sub-tasks for different devices.

In another example, the above-mentioned capability of power consumption may be considered e.g. when there is a need to satisfy the main task in an environmental-friendly manner. This approach could thus be used when the main task from the client is particularly sensitive to environmental-friendly activities. For example, if a client would like to utilize calculation power in devices to calculate statistics on world pollution or the like, this solution could fittingly be used to limit the power consumption of executing this task by preferably selecting sub-tasks for devices that are powered by sun energy. The task manager 202 could thus distribute sub-tasks to sun energy powered devices and further to those devices located in a time zone currently having daylight.

Returning to FIG. 2, a following action 2:7 illustrates that device A at some point executes the received sub-task(s), e.g. by running a java script or the like provided therein. The device A may preferably execute the sub-task(s) “in the background”, i.e. basically without intruding on the normal use of the device such as during idle periods or the like. Further, device A may execute the sub-task(s) during the service usage, such as during a browsing session if the service node is a web server, or in connection with a download or streaming operation if the service node is a media provider, although preferably without affecting the service such that the device user will not notice.

After completing the sub-task(s), the device A sends a result of the executed sub-task(s) to the task manager 202, in an action 2:8, or alternatively to the service node X which then can forward the result to the task manager 202, not shown here. In a similar manner, further devices 206 connected to further service nodes Y, Z, . . . may likewise send their results of executed sub-actions to the task manager 202, illustrated by an optional action 2:8a. As mentioned above, any device 206 may alternatively send the result to its connected service node which in turn deliver the results to task manager 202, not shown here for simplicity. Next, when all necessary sub-tasks have been completed and delivered, the task manager 202 aggregates a total result of the requested main task from the received results of the sub-tasks, in an action 2:9. The task manager 202 then finally returns the total task result to the client 200, in an action 2:10, in response to the task request of action 2:1.

In this way, a huge amount of computational resources and capacity may become potentially available in numerous devices, which can be utilized for executing computational tasks almost of any magnitude since the amount of resources and capacity is far greater than what can be achieved with the above-described conventional technique of using dedicated resources in a cloud owned and maintained by a cloud computing provider. For example, a web server may have thousands of visitors per day whose devices can be utilized in the above-described manner for getting sub-tasks executed.

In the above-described solution, the owner of the task manager is not compelled to own and maintain any amount of dedicated resources, which is naturally associated with costs, although the solution does not exclude complementary use of such dedicated resources to some extent in a cloud. At the same time, the owners of service nodes X, Y, Z, . . . have the possibility to use this solution as a payment for consumed services if the task manager somehow provides compensation in a suitable manner for executed and delivered sub-tasks. The device users in turn may well find this way of paying for services quite attractive, e.g. as an alternative to pay from an account or to being subjected to sometimes irritating commercials and advertising, since executing a sub-task in a device should go virtually unnoticed by its user. Therefore, the users should be inclined to accept the utilization of resources in their devices.

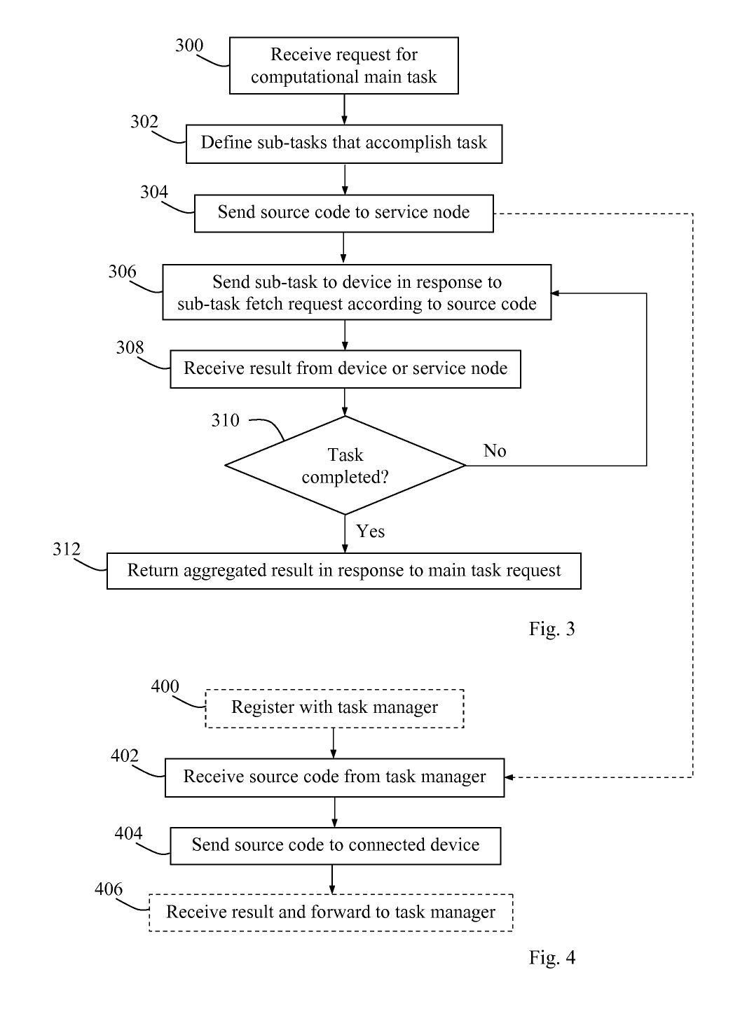

A procedure in a task manager for realizing a requested computational main task, will now be described with reference to the flow chart in FIG. 3, illustrating actions executed in the task manager. It is assumed that the task manager registers or has registered one or more service nodes as distributors of sub-tasks, such as the service nodes X, Y, Z, . . . in FIG. 2, which may be done in beforehand or as triggered when a task request is received. The procedure illustrated in FIG. 3 is thus directed to how a requested computational main task is handled by the task manager, and the task manager 202 described for FIG. 2 may be used also in the procedure of FIG. 3.

A first action 300 illustrates that the task manager receives a request for a computational main task, basically corresponding to action 2:1 in FIG. 2. This task request may be received from any client in need of getting the main task executed. In a next action 302, the task manager defines a set of sub-tasks that accomplish said main task, i.e. the main task is divided into sub-tasks in this action, basically corresponding to action 2:2 in FIG. 2. In a further action 304, the task manager sends a source code to a service node, the source code comprising a device instruction to fetch and execute at least one of said sub-tasks from the task manager, for a device connected to the service node, basically corresponding to what happens in action 2:3 in FIG. 2. The service node is now ready to send the source code to any device that connects to the service node, e.g. for consuming a service therefrom.

Another action 306 illustrates that the task manager sends the at least one sub-task to the device in response to a sub-task fetch request sent from the above device according to said device instruction in the source code, basically corresponding to action 2:6 in FIG. 2. At some point, the task manager receives a result of executed sub-task(s) from the device, in a further action 308, basically corresponding to action 2:8 in FIG. 2. Alternatively, the task manager may receive said result from the service node if the device instead delivers the result to the service node, which is another possibility in this solution.

the task manager may check, in a further action 310, if enough sub-task results have been delivered such that the main task has been completed. If not, the process may repeat actions 306 and 308 for another device and this procedure may be repeated for a number of devices, until the main task has been completed as checked in action 310. Finally, in a last shown action 312, the task manager returns an aggregated result of the requested main task from received results of the defined sub-tasks, in response to the main task request, when the main task has been completed. This action basically corresponds to actions 2:9 and 2:10 in FIG. 2.

A procedure in a service node for enabling a requested computational main task, will now be described with reference to the flow chart in FIG. 4, illustrating actions executed in the service node. The procedure illustrated in FIG. 3 is thus directed to how the service node can contribute to getting the main task executed by means of sub-tasks, and the service node X described for FIG. 2 may be used also in the procedure of FIG. 4.

A first action 300 illustrates that the service node registers with a task manager as a distributor of sub-tasks, basically corresponding to action 2:3 in FIG. 2, which may be done in beforehand or as triggered when the task manager receives a task request from a client. As described above, the task manager may register one or more further service nodes, such as the service nodes X, Y, Z, . . . in FIG. 2, which is however outside the scope of the procedure of FIG. 4.

A next action 402 illustrates that the service node receives a source code from the task manager, the source code comprising a device instruction to fetch at least one sub-task from the task manager selected from a set of defined sub-tasks that accomplish said main task. This action may be regarded as a part of the registration of action 400, and corresponds to the action 304 above where the task manager sends the source code.

Another action 404 illustrates that the service node sends the source code to a device that is connected to the service node, to entail the device to fetch and execute the at least one sub-task according to said instruction in the source code. The device is now able to send a sub-task fetch request to the task manager according to the device instruction in the source code, in order to execute at least one sub-task received from the task manager. In a final shown optional action 406, the service node may, depending on the implementation, receive a result of executed sub-task(s) from the device which is duly forwarded to the task manager.

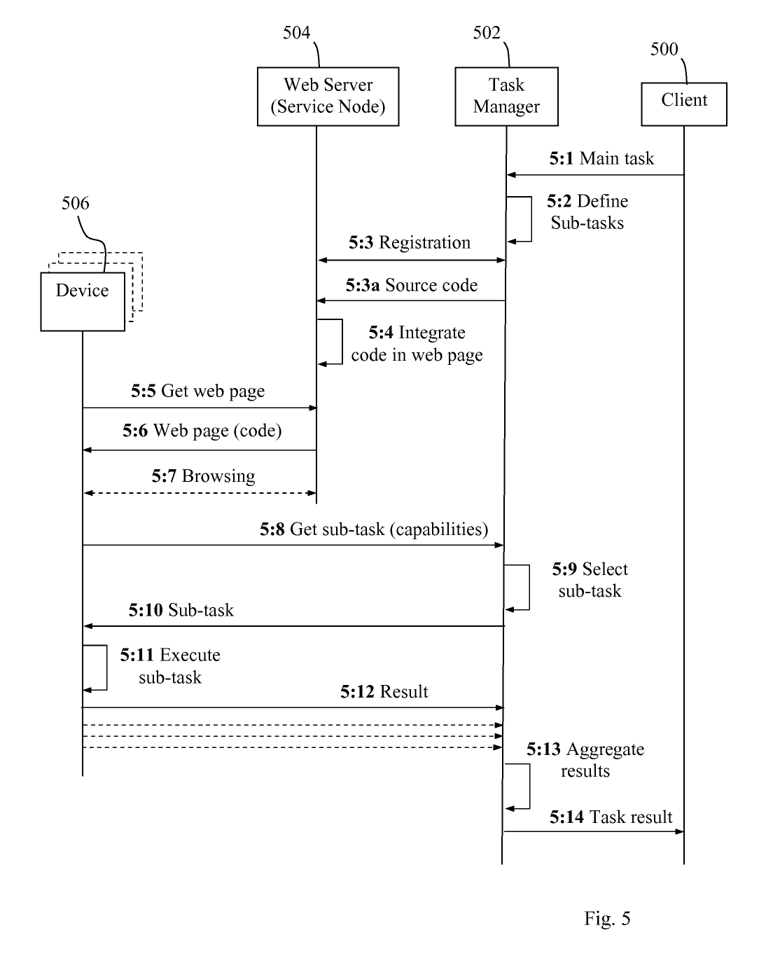

An example of how this solution can be used in practice in the case of web browsing with a web server acting as service node, will now be described with reference to the signalling diagram in FIG. 5. The diagram thus comprises a client 500, a task manager 502, a web server 504 and a device 506 which may represent any number of devices in this process, as indicated by dashed boxes. A first action 5:1 indicates that the task manager 502 receives a request from client 500 to execute a computational main task, and a next action 5:2 further indicates that the task manager 502 defines a set of sub-tasks that altogether accomplish the requested main task.

In another action 5:3, the task manager 502 registers web server 504 as a distributor of sub-tasks, and sends a source code to the web server 504, as illustrated by a separate action 5:3a, which can be regarded as a part of the registration procedure. As in the previous examples, the source code comprises a device instruction to fetch at least one sub-task from the task manager 502. The web server 504 then integrates the received source code in a web page, in a next action 5:4, which may be done in a selection of web pages that may be requested by connected devices.

At some point, the device 506 connects to the web server 504 and sends a “get” request for the web page in action 5:5 containing the source code, which is sent to the device 504 in a following action 5:6. Another action 5:7 illustrates that the device 506 basically consumes a service from web server 504 involving a browsing session in this case. This service may be consumed for any amount of time, which has no impact on the following actions in this procedure which are performed in the background without affecting the service. The communication between device 506 and web server 504 in actions 5:5-5:7 may involve messages sent using http (hyper text transfer protocol) and containing information according to any of: html (hyper text mark-up language), java scripts, plain old java objects (e.g. “pojo”), json, etc. For example, the source code embedded in the web page may be sent to the device 506 in an html format in action 5:6.

Having received the source code in action 5:6, e.g. in the form of a java script embedded in the web page, the source code is automatically executed in the device 506 causing the device to first send a sub-task fetch request denoted “get sub-task” to the task manager 502, in a next action 5:8, according to the device instruction in the source code. In this example, the sub-task fetch request from the device comprises capabilities of the device. The task manager 502 then selects a sub-task for the device 506, in a further action 5:9, based on the device capabilities included in the received get request of action 5:8. In this action, more than one sub-task may be selected for the device and the solution is not limited in this respect.

Another action 5:10 illustrates that the task manager 502 sends the selected sub-task to the device 506, e.g. in the form of a java script as described above. The device 506 then accordingly executes the received sub-task, in an action 5:11, which may be performed immediately or over an extended time period, depending on the nature of the sub-task and on a current amount of free capacity in the device 506. Another action 5:12 illustrates that the device 506 sends a result of the executed sub-task to the task manager 502. Further dashed arrows indicate that more results of executed sub-tasks may also be delivered from other devices to the task manager 502.

Finally, the task manager 502 determines that enough sub-task results have been delivered such that a total result of the main task can be aggregated from the sub-task results, in an action 5:13. The task manager 502 then also returns the total result of the main task to the client 500, in an action 5:14, in response to the task request of action 5.1.

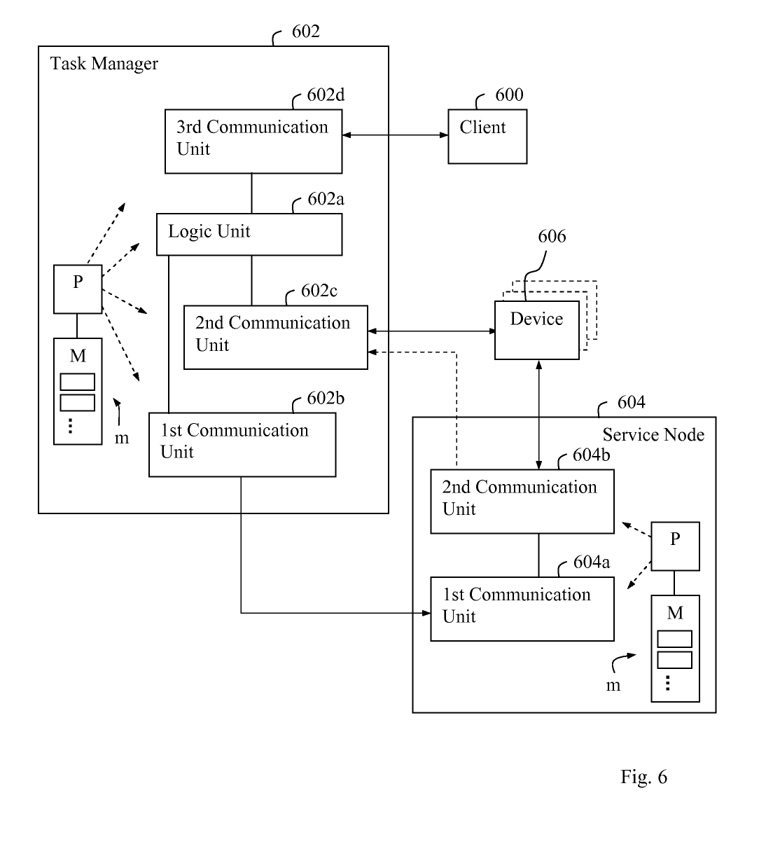

A detailed but non-limiting example of how a task manager and a service node can be configured to accomplish the above-described solution, is illustrated by the block diagram in FIG. 6. The task manager 602 is configured to realize a requested computational main task, and the service node 604 is configured to enable the requested computational main task, e.g. according to the procedures described above for any of FIGS. 2-5, respectively. The task manager 602 and the service node 604 will now be described in terms of a possible example of employing the solution. In this case, the task manager 602 has received the requested computational main task from a client 600 in need of having the main task executed.

The task manager 602 comprises a logic unit 602a adapted to define a set of sub-tasks that accomplish the received main task, such as in action 302 of FIG. 3. Preferably, at least some of the sub-tasks should be defined to be suitable for execution in one or more devices. The task manager 602 further comprises a first communication unit 602b adapted to send a source code to the service node 604, such as in action 304 of FIG. 3. The source code comprises a device instruction to fetch and execute at least one of said sub-tasks from the task manager 602, for a device 606 connected to the service node 604. The source code can thus be sent to the device 606 as well as to any number of further devices, as indicated by dashed boxes.

The task manager 602 also comprises a second communication unit 602c adapted to send the at least one sub-task to the device 606, such as in action 306 of FIG. 3, in response to a sub-task fetch request sent from the device according to the device instruction in the source code which has been sent to the device 606 from the service node 604. The second communication unit 602c is also adapted to receive a result of executed sub-task(s) from the device 606, such as in action 308 of FIG. 3. Alternatively, the second communication unit 602c may receive the result from the service node 604, as indicated by the dashed arrow to 602c, if the device delivers the result to the service node.

The task manager 602 also comprises a third communication unit 602d adapted to return an aggregated result of the requested main task from received results of the defined sub-tasks, in response to the main task request, when the main task has been completed, such as in action 312 of FIG. 3. In this case, the aggregated result is returned to client 600. The third communication unit 602d may also be used for receiving the initial requested computational main task from client 600, such as in action 300 of FIG. 3. In another possible embodiment, the logic unit 602a may be further adapted to select the at least one sub-task for the device based on capabilities of the device comprised in said sub-task fetch request sent from the device, as explained and exemplified above for action 2:6.

The service node 604 comprises a first communication unit 604a adapted to receive the above source code from the task manager 602, such as in action 402 of FIG. 4, said source code comprising a device instruction to fetch at least one sub-task from the task manager selected from a set of defined sub-tasks that accomplish said main task. The service node 604 further comprises a second communication unit 604b adapted to send the source code to the device 606 that is connected to the service node, such as in action 404 of FIG. 4, to entail the device to fetch and execute the at least one sub-task according to the instruction in the source code. In case the device 606 delivers the result of executed sub-task(s) to service node 604, the second communication unit 604b may be further adapted to forward the received result to the task manager 602, indicated by the dashed arrow to 602c, such as in the optional action 406 of FIG. 4. The second communication unit 604b may be further adapted to send the source code to the device 606 upon receiving a service request.

It should be noted that FIG. 6 illustrates various functional units in the task manager 602 and the web server 604 and the skilled person is able to implement these functional units in practice using suitable software and hardware means. Thus, this aspect of the solution is generally not limited to the shown structures of the task manager 602 and the web server 604, and the functional units 602a-d and 604a-b may be configured to operate according to any of the features described in this disclosure, where appropriate.

The functional units 602a-d and 604a-b described above can be implemented in the task manager 602 and the web server 604, respectively, by means of program modules of a respective computer program comprising code means which, when run by processors “P” causes the task manager 602 and the web server 604 to perform the above-described actions. Each processor P may comprise a single Central Processing Unit (CPU), or could comprise two or more processing units. For example, each processor P may include general purpose microprocessors, instruction set processors and/or related chips sets and/or special purpose microprocessors such as Application Specific Integrated Circuits (ASICs). Each processor P may also comprise a storage for caching purposes.

Each computer program may be carried by a computer program product “M” in the task manager 602 and the web server 604, respectively, in the form of a memory having a computer readable medium and being connected to the processor P. Each computer program product M or memory thus comprises a computer readable medium on which the computer program is stored e.g. in the form of computer program modules “m”. For example, the memory M may be a flash memory, a Random-Access Memory (RAM), a Read-Only Memory (ROM) or an Electrically Erasable Programmable ROM (EEPROM), and the program modules m could in alternative embodiments be distributed on different computer program products in the form of memories within the task manager 602 and the web server 604, respectively.

The above-described solution thus offers the possibility to utilize a great amount of distributed resources and capacity in any number of user-controlled devices, without having to buy and/or use dedicated resources in a cloud or the like. The process can be wholly automatic and needs no human efforts, provided that the logic in the task manager is capable of defining appropriate sub-tasks to achieve the main task. The service node is only required to supply the source code to connected devices and the source code will then be executed automatically in the devices such that the latter need no modification at all to act in accordance with this solution.

While the solution has been described with reference to specific exemplary embodiments, the description is generally only intended to illustrate the inventive concept and should not be taken as limiting the scope of the solution. For example, the terms “resources”, “main task”, “sub-task”, “client”, “task manager”, “service node” and “source code” have been used throughout this description, although any other corresponding nodes, functions, and/or parameters could also be used having the features and characteristics described here. The solution is defined by the appended claims.

1. A method in a task manager (202) for realizing a requested (300) computational main task, the method comprising:
defining (302) a set of sub-tasks that accomplish said main task,
sending (304) a source code to a service node (X, 204), said source code comprising a device instruction to fetch and execute at least one of said sub-tasks from the task manager, for a device (A, 206) connected to the service node,
sending (306) the at least one sub-task to the device in response to a sub-task fetch request sent from the device according to said device instruction in the source code,
receiving (308) a result of executed sub-task(s) from the device, or from the service node if the device delivers the result to the service node, and
returning (312) an aggregated result of the requested main task from received results of the defined sub-tasks, in response to the main task request, when said main task has been completed.

2. A method according to claim 1, wherein said set of sub-tasks involve operations for processing data that resides in the device or in a data storage that can be accessed by the device.

3. A method according to claim 1 or 2, wherein said sub-task fetch request from the device comprises capabilities of the device, and the at least one sub-task is selected for the device based on said capabilities.

4. A method according to claim 3, wherein said capabilities refer to any of: computing resources, graphical resources, storing capacity, communication bandwidth, device availability and power consumption.

5. A task manager (602) configured to realize a requested computational main task, comprising:
a logic unit (602a) adapted to define a set of sub-tasks that accomplish said main task,
a first communication unit (602b) adapted to send a source code to a service node (604), said source code comprising a device instruction to fetch and execute at least one of said sub-tasks from the task manager, for a device (606) connected to the service node,
a second communication unit (602c) adapted to send the at least one sub-task to the device in response to a sub-task fetch request sent from the device according to said device instruction in the source code, and to receive a result of executed sub-task(s) from the device, or from the service node if the device delivers the result to the service node, and
a third communication unit (602d) adapted to return an aggregated result of the requested main task from received results of the defined sub-tasks, in response to the main task request, when said main task has been completed.

6. A task manager according to claim 5, wherein said set of sub-tasks involve operations for processing data that resides in the device or in a data storage that can be accessed by the device.

7. A task manager according to claim 5 or 6, wherein the logic unit (602a) is further adapted to select the at least one sub-task for the device based on capabilities of the device comprised in said sub-task fetch request sent from the device.

8. A task manager according to claim 7, wherein said capabilities refer to any of: computing resources, graphical resources, storing capacity, communication bandwidth, device availability and power consumption.

9. A computer program, comprising computer readable code means, which when run in a task manager according to any of the claims 5-8 causes the task manager to perform the corresponding method according to any of the claims 1-4.

10. A computer program product, comprising a computer readable medium and a computer program according to claim 9, wherein the computer program is stored on the computer readable medium.

11. A method in a service node (X, 204) for enabling a requested computational main task, the method comprising:
receiving (402) a source code from a task manager (202), said source code comprising a device instruction to fetch at least one sub-task from the task manager selected from a set of defined sub-tasks that accomplish said main task, and
sending (404) the source code to a device (A, 206) that is connected to the service node, to entail the device to fetch and execute the at least one sub-task according to said instruction in the source code.

12. A method according to claim 11, wherein the source code is sent to the device upon receiving a service request.

13. A method according to claim 11 or 12, wherein the service node is a web server and the source code instructs the device to execute the at least one sub-task during a browsing session with the web server.

14. A service node (604) configured to enable a requested computational main task, comprising:
a first communication unit (604a) adapted to receive a source code from a task manager (602), said source code comprising a device instruction to fetch at least one sub-task from the task manager selected from a set of defined sub-tasks that accomplish said main task, and
a second communication unit (604b) adapted to send the source code to a device (600) that is connected to the service node, to entail the device to fetch and execute the at least one sub-task according to said instruction in the source code.

15. A service node according to claim 15, wherein the second communication unit (604b) is further adapted to send the source code to the device upon receiving a service request.

16. A service node according to claim 14 or 15, wherein the service node is a web server and the source code instructs the device to execute the at least one sub-task during a browsing session with the web server.

17. A computer program, comprising computer readable code means, which when run in a service node according to any of the claims 14-16 causes the service node to perform the corresponding method according to any of the claims 11-13.

18. A computer program product, comprising a computer readable medium and a computer program according to claim 17, wherein the computer program is stored on the computer readable medium.
